(19) United States
(12) Patent Application Publication
(10) Pub. No.: US 2016/0052748 A1
(43) Pub. Date: Feb. 25, 2016

(54) METHOD AND ARRANGEMENT FOR CLOSING DOORS OF AN ELEVATOR

(71) Applicants: Marja-Liisa SIIKONEN, Helsinki (FI); Janne SORSA, Helsinki (FI); Pentti ALASENTIE, Espoo (FI)

(72) Inventors: Marja-Liisa SIIKONEN, Helsinki (FI); Janne SORSA, Helsinki (FI); Pentti ALASENTIE, Espoo (FI)

(73) Assignee: KONE CORPORATION, Helsinki (FI)

(21) Appl. No.: 14/826,903

(22) Filed: Aug. 14, 2015

(30) Foreign Application Priority Data
Aug. 22, 2014 (FI) 20145736

(51) Int. Cl. B66B 13/12; B66B 5/02

(52) U.S. Cl. CPC B66B 13/12; B66B 5/027

(57) ABSTRACT

The invention relates to a method and arrangement for closing doors of an elevator that comprises at least an elevator shaft, a car running along guide rails, in the shaft and equipped with a car door, landing doors at each landing floor, a hoisting machinery, a necessary roping system and shaft equipment, and a control system for controlling the activities of the elevator. According to traffic situations controlled by the control system of the elevator the door open time of the car doors and landing doors is reduced by speeding up the closure of the doors, and at the same time the passengers are informed about the speed-up.

This application claims priority to Finland Patent Application No. 20145736 filed on Aug. 22, 2014, the entire contents of which are incorporated herein by reference.

The present invention relates to a method as defined in the preamble of claim 1 and an arrangement as defined in the preamble of claim 7 for closing doors of an elevator.

The solution according to the invention is suitable for all kinds of elevator systems where automatic doors are used, and specially the solution according to the invention suits for using in multi-car elevator shaft systems. The term multi-car elevator shaft system in this connection means an elevator system where two or more elevator cars are running independently from each other in one elevator shaft. The system can comprise only one shaft or two shafts. In case of one shaft each elevator car can be moved independently, so they can be stopped on a floor, moved downwards or moved upwards. The control system of the elevator keeps track of the locations and motions of the cars so that no collisions can take place. In case of two shafts two or more elevator cars move always in one direction in one elevator shaft. For example the elevator cars move downwards in the first shaft of the system and upwards in the second shaft of the system. The elevator cars change the shaft, for example horizontally, at the bottom floor and at the top floor.

However, the multi-car elevator shaft systems mentioned above may encounter problems when an elevator car stopped at a floor keeps its doors open to long and the next car is approaching the floor where the car with the door open stays. The reason behind too long door open times can be passengers who keep the doors open too long, or a malfunction of the door operator. In those cases one elevator car may stop the operation of the whole shaft or the whole elevator system and the cars coming behind the stuck one need to wait for the route clearance. Another type of problem occurs with a malfunction of the door operator when the doors stick in an open position. In the situation like this it is very dangerous to move the elevator car. If the landing door sticks in an open position and the car is moved away there is a danger of people falling into the elevator shaft through the open doorway. And if only the car door sticks in an open position and the car is moved there is a danger of passengers being injured if they sway outwards through the open doorway.

The object of the present invention is to eliminate the drawbacks described above and to achieve a reliable, well functioning and safe method and arrangement in an elevator system for closing doors of the elevator. Another object of the present invention is to achieve a method and arrangement in an elevator system to improve the capacity of the elevator and the overall ride comfort of the elevator system. Yet another object of the present invention is to adopt the same method and arrangement for closing doors in a multi-car elevator shaft system.

The method for closing doors of the elevator according to the invention is characterized by what is presented in the characterization part of claim 1. Correspondingly the arrangement for closing doors of the elevator according to the invention is characterized by what is presented in the characterization part of claim 7. Other embodiments of the invention are characterized by what is presented in the other claims.

The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment can also be applied in other embodiments. In addition it can be stated that at least some of the subordinate claims can, in at least some situations, be deemed to be inventive in their own right.

The solution according to the invention is characterized by the fact that a shortening of door open times is done, for example by speeding up the closure time of the doors, and at the same time the passengers are informed about the speed-up, for instance with a nudging sound. Passengers who do not react to the speed-up information quickly enough have to wait for the next suitable car.

In a more generic sense the car traffic is maintained by controlling door open times so that the cars do not disturb each other. For that purpose also the speed of the second car coming after the first car can adjusted slower if that kind of need exists.

The method and arrangement according to the invention, shortly the solution according to the invention has the advantage among other things that it makes it possible to speed up the transportation function of the elevator. Another advantage is that it makes it possible to achieve a reliable and safe multi-car elevator shaft system where one elevator car with doors open too long cannot prevent the next car behind it from coming to the floor in a scheduled time. The solution also makes it possible to achieve a reliable and safe multi-car elevator shaft system where elevators cars can be moved safely though either the principal car door or landing door is stuck in an open position. Still one advantage is that the multi-car solution according to the invention increase the handling capacity per shaft, and therefore a building core space can be reduced more than, for example, with existing double-deck elevator solutions.

A suitable way to carry out the invention is that the door open time before starting the door closure is shortened. Also it is suitable to speeding up the closure time in this connection.

In the following, the invention will be described in detail by the aid of examples of two multi-car elevator shaft systems by referring to the attached simplified and diagrammatic drawings, wherein

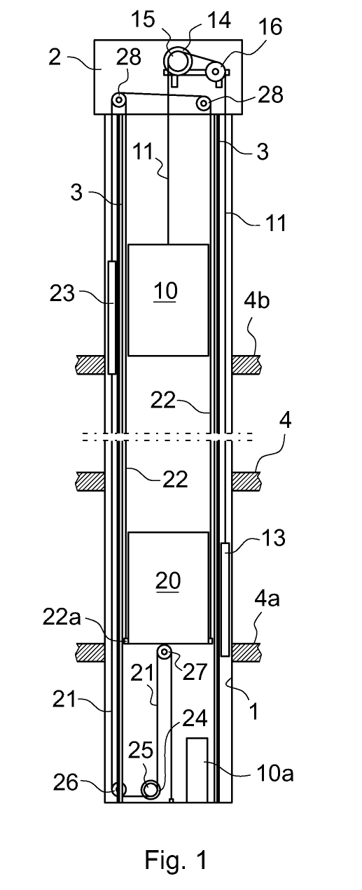

FIG. 1 presents in a simplified and diagrammatic front view a one-shaft elevator arrangement according to the invention with two elevator cars in the same shaft,

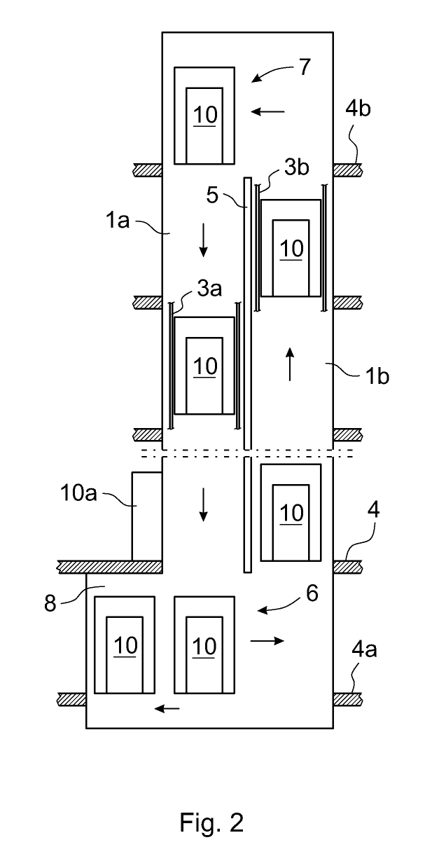

FIG. 2 presents in a simplified and diagrammatic front view a two-shaft elevator arrangement according to the invention with two or more elevator cars in the first elevator shaft moving downwards and two or more elevator cars in the second elevator shaft moving upwards, and

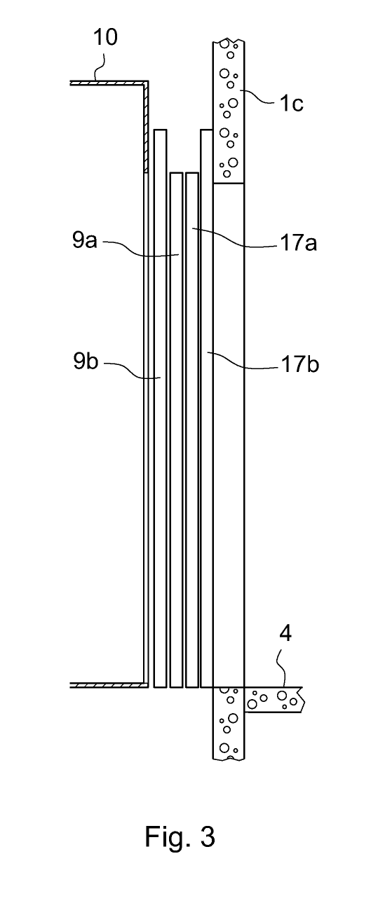

FIG. 3 presents in a simplified and diagrammatic side view a front part of an elevator car with elevator doors according to the invention at a landing floor.

FIG. 1 presents in a simplified and diagrammatic front view one type of an elevator arrangement according to the invention with two elevator cars 10 and 20 running in the same elevator shaft 1. The first or the uppermost elevator car 10 is driven by a first hoisting machinery 14 equipped with a traction sheave 15 and a diverting pulley 16. In this example the hoisting machinery 14 is placed in a separate machine room 2 above the elevator shaft 1 but it could as well be placed also at the upper part of the elevator shaft 1, either on the wall of the elevator shaft 1 or at the guide rail 3 of the elevator cars 10, 20.

A hoisting rope 11 is installed between the first elevator car 10 and its counterweight 13 that can also be a compensating weight. The hoisting rope 11 in all embodiments of the invention can be a single rope or a bunch of similar parallel ropes. A first end of the hoisting rope 11 is secured at the upper part of the uppermost elevator car 10 and from the elevator car 10 the hoisting rope 11 is passed around and over the traction sheave 15 of the first hoisting machinery 14, and from the traction sheave 15 the hoisting rope 11 is further passed over the diverting pulley 16 to a first counterweight 13. The suspension ratio in the suspension like this is 1:1. The uppermost elevator car 10 is arranged to run through the whole elevator shaft 1 from the lowermost floor level 4a to the uppermost floor level 4b and vice versa.

The second or the lowermost elevator car 20 is driven by a second hoisting machinery 24 equipped with a drive wheel 25. In this example the second hoisting machinery 24 is placed in the lower part of the elevator shaft 1 below the second elevator car 20. First ends of the two suspension ropes 22 have been secured at the lower part of the lowermost elevator car 20 each end at its own side of the lowermost elevator car 20 where fastening points 22a are situated. From the fastening points 22a the suspension ropes 22 are passed around and over the diverting pulleys 28 that are placed in the machine room 2 or at the upper part of the elevator shaft 1 so high that the lowermost elevator car 20 can be landed at the uppermost floor level 4b of the elevator shaft 1. And finally from the diverting pulleys 28 the suspension ropes 22 are led to a second counterweight 23 that can also be a compensating weight.

The supporting and moving of the lowermost elevator car 20 are separated from each other. The arrangement comprises a separate traction member 21 that is connected between the second counterweight 23 and the second elevator car 20. The traction member 21 can be a single member or a bunch of similar parallel members, for instance the traction member 21 can be a toothed belt, chain or other type of member that does not slip on the drive wheel 25.

A first end of the traction member 21 is secured in its fastening point at the bottom of the elevator shaft 1 or at another appropriate place at the lower part of the elevator shaft 1. From the first end fastening point the traction member 21 is passed around and over the diverting pulley 27 that is placed at the lower part of the elevator car 20 and from the diverting pulley 27 the traction member 21 is passed under the drive sheave 25 of the second hoisting machinery 24, and from the drive sheave 25 the traction member 21 is further passed under a diverting pulley 26 to the second counterweight 23 where a second end of the traction member 21 is secured to the second counterweight 23. The suspension ratio in the suspension like this is 2:1. The lowermost elevator car 20 is also arranged to run through the whole elevator shaft 1 from the lowermost floor level 4a to the uppermost floor level 4b and vice versa.

In the arrangement according to FIG. 1 both the elevator cars 10, 20 are running along the same guide rails 3. The control system 10a of the elevator system has been arranged so that the elevator cars 10, 20 can move freely in the elevator shaft 1 without colliding each other. Thus, the elevator cars 10 and 20 can move simultaneously towards each other, away from each other, to the same direction, or the uppermost car 10 can move when the lowermost car 20 is stopped on the landing floor 4, 4a or 4b, or vice versa.

FIG. 2 presents in a simplified and diagrammatic front view a two-shaft elevator arrangement according to the invention with two or more elevator cars 10 in the first elevator shaft la moving downwards and two or more elevator cars 10 in the second elevator shaft 1b moving upwards. This kind of multi-car elevator shaft system can be used, for instance, in normal high-rise buildings to replace elevator groups serving multiple floors.

All the elevator cars 10 are arranged to move independently from each other always in the same direction in one shaft 1a, 1b. The elevator cars 10 are self-propelled or moved by a special hoisting machinery. For the sake of clarity elevator hoisting machineries and roping system are not presented in FIG. 2, and the guide rails 3a and 3b are presented only partially. The two shafts 1a and 1b are separated from each other with a separating wall 5 that has a first opening 6 at the lowermost part of the separating wall 5 and a second opening 7 at the uppermost part of the separating wall 5. The openings 6 and 7 are used to move the elevator cars 10 horizontally from the first shaft la to the second shaft 1b, and vice versa. For the horizontal motion of the cars 10 the elevator arrangement is equipped with additional transfers machineries and horizontal guide rails or corresponding means. However, for the sake of clarity these additional elements are not presented in FIG. 2.

The elevator arrangement according to the invention comprises also a maintenance or fixing space 8 of the elevator cars 10. In case of a failure, for example a door failure, the inoperative elevator car 10 is moved to the maintenance space 8 in order to get it away from blocking the running of other elevator cars 10, and to rescue possible passengers from the elevator car 10. The maintenance space 8 is at a side of the first elevator shaft 1a at the bottom level of the shaft or at the lowermost floor level 4a. Special horizontal guide rails are arranged to guide the elevator car 10 to the maintenance space 8. As well maintenance space 8 could be situated at a side of each shaft 1a or 1b and at any height or at any floor level, or even in a space between the two shaft 1a and 1b.

In multi-car elevator shafts the elevators cars ahead of another cars can slow down the whole elevator system if they stop at a floor level 4, 4a, 4b for too long a time. For that reason the door open times should have quite a short limit for keeping doors open at a floor. A suitable time period is, for example, 10-30 seconds depending on the floor. On the entrance floor longer door open times are acceptable as possibly large amount of passengers enter and exit a car, but on upper floors only short door open times are allowed. A typical stop times or door open times could be learned by the elevator control system 10a.

The elevator arrangement according to the invention comprises means for monitoring door open times and in case the pre-defined time limit for the open time has passed the monitoring means are arranged to send orders to close the open door as fast as possible. In addition the elevator arrangement has means for warning passengers about the closing door, for example with a nudging sound, such as in metro or underground systems. Instead of the nudging sound another type of a warning and information message can also be given to the passengers.

For situations when the normal landing door 17a or car door 9a does not close when the accelerated door closing is activated, the elevator arrangement according to the invention is equipped with additional doors or door-like elements that are explained below in connection with FIG. 3.

FIG. 3 presents in a simplified and diagrammatic side view a part of an elevator car 10 with elevator doors according to the invention on a landing floor 4. Each elevator car 10 has a substantially normal car door 9a and an additional safety door 9b that is arranged to close the car doorway if the normal car door 9a fails to close. In this case the safety door 9b are closer to the elevator car 10 than the normal door 9a but they could be situated also vice versa.

In addition the elevator arrangement according to the invention has substantially normal landing doors 17a at each floor level 4, 4a, 4b, and an additional safety landing door 17b that is arranged to close the landing doorway if the normal landing door 17a fails to close. In this case the safety door 17b are closer to the wall 1c of the elevator shaft than the normal landing door 17a but they could be situated also vice versa. The safety doors 9b and 17b that act as additional safety elements can also be like grid walls and they can be moved either horizontally or vertically.

In case the normal landing door 17a does not close, the additional safety landing door 17b closes with a nudging sound and the car door 9a closes independently. After that the elevator car 10 can move forward, away from the cars coming behind, and the landing doorway at the floor level is safe thanks to the safety landing door 17b.

The arrangement according to the invention comprises means for detecting passengers inside the stopped car, and means for moving the car 10 with the additional safety door 9b in a closed position. In case of a failure in the car door 9a, so that the car door 9a does not close, and when there are passengers inside the car 10, the additional safety door 9b closes with a nudging sound, and the car 10 is moved to the maintenance space 8 for the rescue of the passengers and for the door maintenance.

Though the method and arrangement has been described above in a multi-car elevator shaft system the invention can also be used in normal one-car elevator shaft systems, and instead of using only in exceptional situations the method and arrangement according to the invention can also be used in normal situations to speed up the closing of the doors and thereby to improve the transportation capacity of the elevator. In that case the speeding up is done according to the traffic situation controlled by the control system 10a of the elevator and the speeding up is informed to the passengers, for example with a nudging sound. In that case the safety doors 9b and 17b are not used at all but the normal doors 9a and 17a are speeded up when needed.

The control system 10a of the elevator has also means for receiving special car calls or calls from landing floors. These calls can be for instance so-called handicap calls for wheelchair passengers. After receiving a call like that the speeding up of the door closing is not activated.

It is obvious to the person skilled in the art that the invention is not restricted to the example described above but that it may be varied within the scope of the claims presented below.

1. Method for closing doors of an elevator that comprises at least an elevator shaft, a car running along guide rails, in the shaft and equipped with a car door, landing doors at each landing floor, a hoisting machinery, a necessary roping system and shaft equipment, and a control system for controlling the activities of the elevator, wherein according to situations the control system of the elevator adjusts door open time of the car doors and landing doors,
wherein in case of two or more cars running in the same shaft the door open times of the doors of the car stopped at a landing floor ahead of other cars in the same shaft are monitored and analyzed, and if the door open time is so long that the stopped car disturbs the motion of at least the next car behind the stopped car, the closure of the doors of the stopped car is speeded-up and substantially at the same time the passengers are informed about the speed-up, for instance with a nudging sound.

2. Method for closing doors of an elevator according to claim 1, wherein the adjustment of the door open times is done by reducing the door open time by speeding up the closure of the doors, and substantially at the same time when the door open time of the car doors and landing doors is reduced the passengers are informed about the speed-up, for instance with a nudging sound.

3. (canceled)

4. Method for closing doors of an elevator according to claim 1, wherein in case of a door failure where the landing door does not close, the landing door opening is closed with an additional safety element and the car door is closed independently, after which the car is moved away from the landing floor level.

5. Method for closing doors of an elevator according to claim 1 above, wherein in case of a door failure where the car door does not close, and there is at least one passenger detected in the car, the car door opening is closed with an additional safety element after which the car is moved away from the landing floor level.

6. Method for closing doors of an elevator according to claim 5, wherein in case of two or more cars running in the same shaft the car having a car door failure is moved to a maintenance or fixing space in connection with the elevator shaft.

7. Method for closing doors of an elevator according to claim 1 above, wherein the door open time before starting the door closure is shortened.

8. Arrangement for closing doors of an elevator that comprises at least an elevator shaft, a car running along guide rails, in the shaft and equipped with a car door, landing doors at each landing floor, a hoisting machinery, a necessary roping system and shaft equipment, and a control system for controlling the activities of the elevator, wherein the arrangement comprises means for monitoring the door open times of the car doors and landing doors and speeding up the closure of said doors according to traffic situations of the elevator controlled by the control system of the elevator,
wherein in case of two or more cars running in the same shaft the arrangement comprises means for monitoring the door open times of the doors of the car stopped at a landing floor ahead of other cars in the same shaft; and means for analyzing if the door open time is so long that the stopped car disturbs the motion of at least the next car behind the stopped car; and means for speeding up the closure of the doors of the stopped car.

9. Arrangement for closing doors of an elevator according to claim 8, wherein the arrangement comprises alarm means for informing the passengers, for instance with a nudging sound, about speed-up of the closure of the doors substantially at the same time with the speed-up.

10. (canceled)

11. Arrangement for closing doors of an elevator according to claim 8, wherein the arrangement comprises an additional safety element for closing the landing door opening in case of a door failure where the landing door does not close.

12. Arrangement for closing doors of an elevator according to claim 8 above, wherein the arrangement comprises an additional safety element for closing the car door opening in case of a door failure where the car door does not close; and means for detecting passengers inside the stopped car; and means for moving the car with the additional safety element in a closed position, if one or more passengers are detected, away from the landing floor level.

13. Arrangement for closing doors of an elevator according to claim 8 above, wherein the arrangement comprises a maintenance or fixing space for maintenance and repair of the elevator cars and for rescuing passengers from the car in case of a closing failure with a car door.
